(19) United States
(12) Patent Application Publication
(10) Pub. No.: US 2026/0346264 A1
(43) Pub. Date: Nov. 5, 2026

(54) AN ARRANGEMENT FOR STATIC CHARGE REDUCTION IN AIR JET MILLING

(71) Applicants: Indu C. N., Bengaluru, Karnataka (IN); K. Nanda KISHORE, Bengaluru, Karnataka (IN)

(72) Inventors: Indu C. N., Bengaluru, Karnataka (IN); K. Nanda KISHORE, Bengaluru, Karnataka (IN)

(21) Appl. No.: 19/119,812

(22) PCT Filed: Oct. 10, 2023
(86) PCT No.: PCT/IN2023/050916

§ 371 Date: Apr. 10, 2025

(30) Foreign Application Priority Data
Oct. 12, 2022 (IN) 202241058349

(51) Int. Cl. B02C 23/04; B02C 19/06

(52) U.S. Cl. CPC B02C 23/04; B02C 19/06

(57) ABSTRACT

The invention provides an arrangement for reducing static charge in air jet milling. The arrangement includes a tubular element having a horizontal tubular element and a vertical tubular element. The vertical tubular element is substantially perpendicular to the horizontal tubular element and joins the horizontal tubular element to form a ‘T’. An ion emitter is placed inside the vertical tubular element and generates alternating charges into the horizontal tubular element. The horizontal tubular element is connected to the pneumatic air supply of the air jet mill. The alternating charges generated by the ion emitter are carried by the pneumatic air supply to the milling chamber of the air jet mill for neutralizing the static charges generated during milling.

### FIELD OF INVENTION

The invention generally relates to the field of static charge elimination and more specifically to an arrangement for reducing static charge in air jet milling.

### BACKGROUND

Jet milling is employed for reducing the size of particles in industries including but not limited to pharmaceutical, chemical, cosmetics, pigment and ceramic industries. Particle size reduction is an important operation in pharmaceutical industry as it fixes the final formulation of drug product and thereby its bio-pharmaceutical performances. In air jet mill, milling of particles is achieved by use of compressed air, gas or high pressure superheated steam. Compressed air or steam is injected into a milling chamber through specially designed nozzles placed at regular distance on the peripheral wall of the milling chamber. The axis of each jet is tangential to the circumference of a smaller, imaginary, concentric circle. These precisely aligned jets create a vortex inside the milling chamber. During operation, the material is fed into this vortex. Strong velocity gradients near the jet cause the suspended particles of the material to collide with each other and reduce themselves by attrition and collision. Size reduction is the result of the high-velocity collisions between particles of the process material itself and no grinding media is involved. The jet fluids exit through an outlet at the center of the milling chamber and draw the milled particles with it to the cyclone collection system. Heavier oversized particles are held in the milling chamber by centrifugal force, until reduced to a desired size.

The advantages of air jet mill include but are not limited to providing smallest particle size (less than 10 micron) with highest specific area, mechanically simple (no rotary parts required) and requires little or no maintenance. However, friction and separation of powder particles during milling may lead to electrostatic charge build-up. The static charge can build up to a dangerously level and then discharge unpredictably. If the energy released during discharge is greater than the minimum ignition energy of the material being grinded, then the material will catch fire or explode.

One of the methods available in the art for controlling static charge in air jet mill is electrical earthing of the air jet mill. However, earthing of the air jet mill does not remove the static charge on insulative materials.

Another such method disclosed by U.S. Pat. No. 3,186,648 for reducing static charge in fluid jet mill include introducing water as atomized spray or as steam into the grinding chamber through a separate nozzle or into the compressed air stream.

Yet another such method discloses use of superheated steam as the grinding working medium to reduce static charges during jet milling of titanium dioxide. One significant disadvantage of the above methods is that, the addition of water or steam in the grinding chamber is not desirable as it lead to increase in moisture content of particles being milled resulting not only in difficulty in reducing the particle size but also change in chemical properties of powder, which is undesirable in pharmaceutical industry.

Still another method disclosed by Yin et al, 2013, for preventing agglomeration of particles in air jet milled powder uses electrostatic dispersion for charging of powder particles. An electrode connected to high voltage DC power is provided inside the jet mill chamber for generating corona discharge and powder particles are charged when they pass through the corona discharge. One significant disadvantage of the method is that the powder particles are already charged after leaving the grinding chamber, passing the powder through corona discharge will lead to further increase in the static charge.

Hence, there is need for a method that reduces the static charges generated during air jet milling and is safe, effective and improves the performance of the air jet mill.

### BRIEF DESCRIPTION OF DRAWINGS

So that the manner in which the recited features of the invention can be understood in detail, some of the embodiments are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic representation of an arrangement for reducing static charge in air jet milling, according to an embodiment of the invention.

FIG. 2 shows a schematic representation of an arrangement for reducing static charge in air jet milling, according to another embodiment of the invention.

FIG. 3 shows a schematic representation of an arrangement for reducing static charge in air jet milling, according to an alternate embodiment of the invention.

FIG. 4 shows a schematic representation of the vertical tubular element of the arrangement for reducing static charge in air jet milling, according to an embodiment of the invention.

FIG. 5 shows an exploded view of the vertical tubular element of the arrangement for reducing static charge in air jet milling, according to an alternate embodiment of the invention.

FIG. 6 shows a schematic representation of an air jet mill with the arrangement for reducing static charge, according to an embodiment of the invention.

### SUMMARY OF THE INVENTION

One aspect of the invention provides an arrangement for reducing static charge in air jet milling. The arrangement includes a tubular element having a horizontal tubular element and a vertical tubular element. The vertical tubular element is substantially perpendicular to the horizontal tubular element and joins the horizontal tubular element to form a ‘T’. An ion emitter is placed inside the vertical tubular element and generates alternating charges into the horizontal tubular element. The horizontal tubular element is connected to the pneumatic air supply of the air jet mill. The alternating charges generated by the ion emitter are carried by the pneumatic air supply to the milling chamber of the air jet mill for neutralizing the static charges generated during milling.

### DETAILED DESCRIPTION OF THE INVENTION

Various embodiments of the invention provide an arrangement for reducing static charge in air jet milling. Air jet milling is a process wherein the size of a particle is reduced to micrometer. For milling, the particles are fed in a milling chamber; compressed air is fed into the milling chamber through special nozzles and is accelerated so strongly that the particles are entrained. In the process, the particles repeatedly collide with each other and with the walls of the milling chamber and are thus reduced in size. Static charges are developed on the particles due to colliding of the particles with each other and with the walls of the milling chamber.

The generated static charge can build up to dangerous levels and then discharge unpredictably. If the energy released in the discharge is greater than the minimum ignition energy of the material undergoing drying, then the material will catch fire and explode. The invention provides an arrangement for removing static charges in air jet milling. The arrangement includes a tubular element having a horizontal tubular element and a vertical tubular element. The vertical tubular element is substantially perpendicular to the horizontal tubular element and joins the horizontal tubular element to form a ‘T’. An ion emitter is placed inside the vertical tubular element and generates alternating charges into the horizontal tubular element. The horizontal tubular element is connected to the pneumatic air supply of the air jet mill. The alternating charges generated by the ion emitter are carried by the pneumatic air supply to the milling chamber of the air jet mill for neutralizing the static charges generated during milling. The arrangement as described herein above briefly shall be explained in detail below. All the terms mentioned in the description herein shall be interpreted in their usual and standard meaning unless otherwise specified.

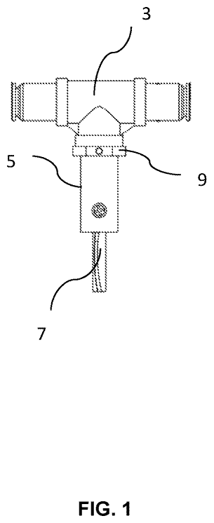

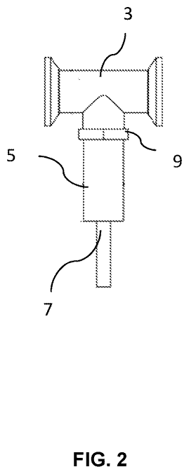

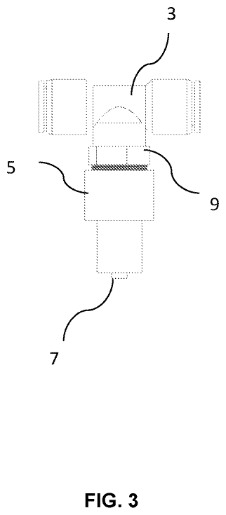

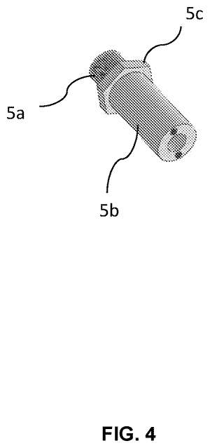

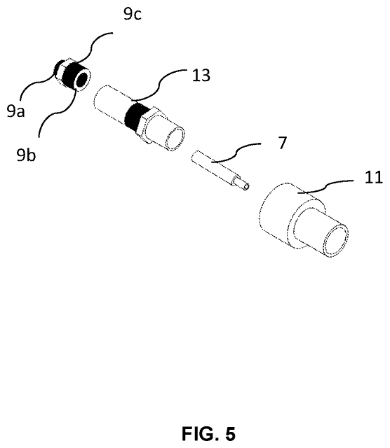

FIG. 1 shows a schematic representation of an arrangement for reducing static charge in air jet milling, according to an embodiment of the invention. The arrangement includes a tubular element having a horizontal tubular element 3 and a vertical tubular element 5. The vertical tubular element 5 is substantially perpendicular to the horizontal tubular element 3 and joins the horizontal tubular element 3 to form a ‘T’. An ion emitter 7 is placed inside the vertical tubular element 5. The vertical tubular element 5 is joined to the horizontal tubular element 3 through a fixture 9. In one embodiment of the invention, the fixture 9 and the vertical tubular element 5 are provided as a uni-body structure. In an alternate embodiment of the invention, the fixture 9 is detachably attached to the vertical tubular element 5 (FIG. 3). The fixture 9 enables leak proof operation of the arrangement by preventing leakage of the ions discharged by the ion emitter 7 to the outside environment. The length of the horizontal tubular element 3 varies from 60 mm to 65 mm. The diameter of the horizontal tubular element varies according to the diameter of pneumatic air supply tube of the air jet mill. The horizontal tubular element and the vertical tubular element are made of the stainless steel. The length of the vertical tubular element varies from 30 mm to 50 mm and the diameter varies from 10 mm to 25 mm. The arrangement is connected to the pneumatic air supply of the air jet mill through the horizontal tubular element 3. In one embodiment of the invention, a pneumatic connector is provided at both the ends of the horizontal tubular element 3 for connecting to the pneumatic air supply. In another embodiment of the invention, a flange is provided at both the ends of the horizontal tubular element 3 for connecting to the pneumatic air supply (FIG. 2). In one embodiment of the invention, the ion emitter 7 is a single pin ion emitter and is connected to an AC voltage supply for emission of both the positive ions and the negative ions into the horizontal tubular element 3. Since, positive and negative ions are generated in each alternate sine wave cycle of the AC voltage supply; the ion recombination is prevented by the time lag of each sine wave cycle. The positive ions and the negative ions emitted by the ion emitter 7 are carried by the air from the pneumatic air supply to the milling chamber. The positive ions and the negative ions neutralize the static charges generated by the collision of the particles being milled in the air jet mill. FIG. 4 shows the schematic representation of the vertical tubular element of the arrangement for reducing static charge in air jet milling, according to an embodiment of the invention. The vertical tubular element 5 further includes a first end 5a, a second end 5b and a middle portion 5c. The first end 5a is tubular shaped and has outer diameter lesser than the middle portion 5c and the second end 5b. The inner diameter of the first end 5a, the second end 5b and the middle portion 5c are equal. The middle portion 5c has hexagonal shaped outer surface and circular inner surface. The second end 5b is tubular shaped and is configured for holding the ion emitter 7. In one example of the invention, the ion emitter 7 is held through a push fit mechanism. The first end 5a of the vertical tubular element 5 is configured to detachably attach with horizontal tubular element 3. The detachable attachment is enabled through either a push fit connection or a threaded connection. In one embodiment of the invention, the first end 5a has threads on the outer surface to fit with counter threads on the horizontal tubular element 3. FIG. 5 shows an exploded view of the vertical tubular element of the arrangement for reducing static charge in air jet milling, according to an alternate embodiment of the invention. The vertical tubular element 5 further includes an outer sleeve 11, an inner sleeve 13 and a fixture 9. The outer sleeve 11 of the vertical tubular element 5 connects with the horizontal tubular element 3 through the fixture 9. The inner sleeve 13 holds the ionizer 7 within the cavity of vertical tubular element 5. The fixture 9 has a first end 9a, a second end 9b and a middle portion 9c. The first end 9a is tubular shaped and has outer diameter lesser than the middle portion 9c and the second end 9b. The inner diameter of the first end 9a, the second end 9b and the middle portion 9c are equal. The middle portion 9c has hexagonal shaped outer surface and circular inner surface. The second end 9b is tubular shaped with threads on the outer surface and the inner surface. The first end 9a of the fixture 9 is configured to detachably attach with horizontal tubular element 3. The detachable attachment is enabled through either a push fit connection or a threaded connection. In one embodiment of the invention, the first end 9a has threads on the outer surface to fit with counter threads on the horizontal tubular element 3. The second end 9b of the fixture 9 is configured to detachably attach with the outer sleeve 11 and the inner sleeve 13. The outer surface of the second end 9b is configured to attach with the outer sleeve 11 while the inner surface is configured to attach with the inner sleeve 13. In one embodiment of the invention, the outer surface and the inner surface have threads to attach with the outer sleeve 11 and the inner sleeve 13, respectively. The ion emitter 7 is attached to the inner sleeve 13 through a push fit mechanism.

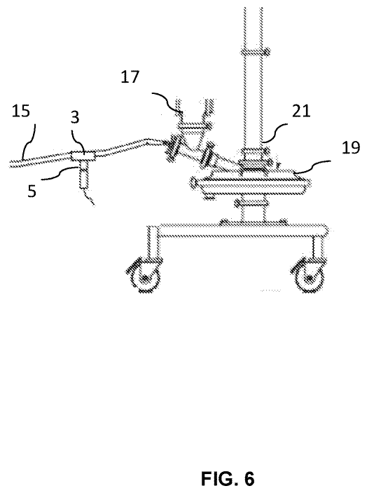

FIG. 6 shows a schematic representation of an air jet mill with the arrangement for reducing static charge, according to an embodiment of the invention. The air jet mill includes an air inlet 15 for flow of pneumatic air, a powder particle feeder 17 in fluid connection with the air inlet 15, an annular milling chamber 19 and an outlet 21 extending axially from the milling chamber 19 for the passage of the milled powder. The annular milling chamber 19 is in fluid connection with the particle inlet 17. An arrangement for reducing the static charge is provided on the compressed air supply. The arrangement includes a tubular element having a horizontal tubular element 3 and a vertical tubular element 5. The vertical tubular element 3 is substantially perpendicular to the horizontal tubular element 5 and joins the horizontal tubular element to form a ‘T’. An ion emitter (not seen) is placed inside the vertical tubular element 5; the ion emitter generates positive and negative ions when an AC voltage is applied. The generated positive ions and negative ions are discharged into the horizontal tubular element 3. Since, the horizontal tubular element is connected to the pneumatic air supply, the generated positive ions and the negative ions are carried by the pneumatic air. The pneumatic air along with the ions also carries the particle from the particle feeder to the annular milling chamber 19. The milling chamber 19 has a plurality of symmetrical circumferentially arranged nozzles for flow of pneumatic air into the milling chamber 19. The particles carried by the pneumatic air, along with the ions, enter the milling chamber 19 through the plurality of symmetrical, circumferentially arranged nozzles. The particles are reduced in size to the extent of micrometer diameter by collision of the particles with each other and with the walls of the milling chamber. Due to the collision and friction of the particles, static charge is generated; these charges are neutralized by the positive ions and the negative ions. After milling, the powdered particles exit through the outlet 21.

Example 1: In one particular example of the invention, the arrangement for reducing static charge in air jet milling include a tubular element 1 having a horizontal tubular element 3 and a vertical tubular element 5. The vertical tubular element 5 is substantially perpendicular to the horizontal tubular element 3 and joins the horizontal tubular element 3 to form a ‘T’. An ion emitter 7 is pushed to fit inside the vertical tubular element 5. The length of the horizontal tubular element is 60 mm and diameter is 16 mm. The length of the vertical tubular element is 50 mm and the inner diameter is 12 mm. The horizontal tubular element, the vertical tubular element and the ion emitter are made of stainless steel 302. The ion emitter 7 is a single pin ion emitter. The arrangement is connected to the pneumatic air supply of the air jet mill through the horizontal tubular element 3. The horizontal tubular element 3 is provided with pneumatic connector of diameter 16 mm on both the sides of the horizontal tubular element 3 for connecting to the pneumatic air supply of the air jet mill. The arrangement is configured to work in air pressure range of 1 to 10 kg/cm². During operation, the ion emitter 7 is connected to 230V AC power supply to obtain 5 KV output and generates positive and negative ions into the horizontal tubular element 3. The generated positive ions and the negative ions are carried by the pneumatic air supply, travelling in the horizontal tubular element 3 to the milling chamber of the air jet mill. The ions neutralize the static charges that are generated in the milling chamber due to the collision of the particles with each other and with the walls of the grinding chamber.

Thus, the static charge is eliminated by the continuous supply of the positive ions and the negative ions and is not allowed to build up. The efficiency of the arrangement in removing static charge in air jet milling is assessed at the milling chamber and at the powder collection bin. Table 1 shows the static charge readings at the milling chamber of the air jet mill.

| Trial type | Trial 1 | Trial 2 | Trial 3 |
|---|---|---|---|
| Without arrangement | 8.5 KV | 9.3 KV | 7.2 KV |
| With arrangement | 2.2 KV | 2.7 KV | 1.9 KV |

Table 2 shows the static charge readings at the powder collection bin of the air jet mill.

| Trial type | Trial 1 | Trial 2 | Trial 3 |
|---|---|---|---|
| Without arrangement | 14.2 KV | 10.7 KV | 12.6 KV |
| With arrangement | 3.3 KV | 1.4 KV | 2.3 KV |

The static charges recorded at milling chamber and the powder collection bin were significantly lower in air jet mill where the arrangement for reducing static charge as provided by the invention is used.

The invention thus provides an arrangement for reducing static charges in air jet milling that is cost effective, efficient and safe and also improves the performance of the air jet mill resulting in good quality milled powder.

The foregoing description of the invention has been set merely to illustrate the invention and is not intended to be limiting. Since modifications of the disclosed embodiments incorporating the spirit and substance of the invention may occur to person skilled in the art, the invention should be construed to include everything within the scope of the appended claims and equivalents thereof.

We claim:

1. An arrangement for reduction of static charge during air jet milling of powder, the arrangement comprising;
a tubular element having a horizontal tubular element (3) and a vertical tubular element (5), wherein the vertical tubular element (5) is substantially perpendicular to the horizontal tubular element (3), wherein the vertical tubular element (5) joins the horizontal tubular element (3) to form a ‘T’; and
an ion emitter (7) held inside the vertical tubular element (5) wherein the ion emitter (7) is capable of generating alternating charges.

2. The arrangement as claimed in claim 1, wherein the ion emitter (7) is held inside the vertical tubular element (5) through a fixture (9) wherein the fixture (9) enables leak proof operation of the arrangement by preventing leakage of the generated ions by the ion emitter (7) to the outside environment.

3. The arrangement as claimed in claim 1, wherein the horizontal tubular element (3) is connected to the pneumatic air supply of the air jet mill.

4. The arrangement as claimed in claim 1, wherein the horizontal tubular element (3) is connected to the pneumatic air supply of the air jet mill through a pneumatic connector or a flange.

5. The arrangement as claimed in claim 1, wherein the vertical tubular element (5) is in fluid communication with the horizontal tubular element (3).

6. The arrangement as claimed in claim 1, wherein the ion emitter (7) is a single pin ion emitter.

7. The arrangement as claimed in claim 1, wherein the ion emitter (7) is connected to an AC voltage supply for generation of positive ions and negative ions, wherein the generated positive ions and the negative ions are discharged as corona discharge into the horizontal tubular element (3).

8. The arrangement as claimed in claim 1, wherein generated positive ions and the negative ions are carried by the pneumatic air supply of the air jet mill to neutralize the static charge developed on the surface of the powder particles during milling.

9. An air jet mill for milling of powders, the air jet miller comprising;
an air inlet (15) for flow of pneumatic air;
a particle feeder (17) in fluid connection with the air inlet (15);
an annular milling chamber (19) in fluid connection with the particle feeder (17), wherein the milling chamber (19) has a plurality of symmetrical circumferentially arranged nozzles for flow of pneumatic air; and
an outlet (21) for the passage of the milled powder extending axially from the milling chamber (19);
characterized in that an arrangement is provided for reduction of static charge during air jet milling of powder, comprising a tubular element having a horizontal tubular element (3) and a vertical tubular element (5), wherein the vertical tubular element (5) is substantially perpendicular to the horizontal tubular element (3), wherein the vertical tubular element (5) joins the horizontal tubular element (3) to form a ‘T’; and an ion emitter (7) placed inside the vertical tubular element (5) wherein the ion emitter (7) is capable of generating alternating charges
wherein the arrangement through the horizontal tubular element (3) is connected to the pneumatic air supply for carrying the generated ions to the milling chamber for neutralization of static charges during milling of powder.
